(19) United States
(12) Patent Application Publication
(10) Pub. No.: US 2010/0295597 A1
(43) Pub. Date: Nov. 25, 2010

(54) MIXER WITH HIGH LINEARITY AND LOW OPERATING VOLTAGE

(75) Inventors: SHUO-YUAN HSIAO, Hsinchu Hsien (TW); CHAO-TUNG YANG, Hsinchu Hsien (TW); MING-CHUNG LIU, Hsinchu Hsien (TW)

Correspondence Address: WPAT, PC;INTELLECTUAL PROPERTY ATTORNEYS, 7225 BEVERLY ST., ANNANDALE, VA, 22003, US

(73) Assignee: MSTAR SEMICONDUCTOR, INC., Hsinchu Hsien (TW)

(21) Appl. No.: 12/542,007

(22) Filed: Aug. 17, 2009

(30) Foreign Application Priority Data
May 19, 2009 (TW) 098116506

(51) Int. Cl. G06G 7/12

(52) U.S. Cl. 327/355

(57) ABSTRACT

A mixer with high linearity and a low operating voltage is provided. The mixer includes a transconductor and a switch circuit. The transconductor receives a differential voltage signal and outputs a differential current signal accordingly. The transconductor includes a first resistor, a second resistor, a differential amplifier, a first current source and a second current source. The switch circuit includes a first switch, a second switch, a third switch, and a fourth switch. The first and second switches are coupled to a first input of the differential amplifier, while the third and fourth switches are coupled to a second input of the differential amplifier. The first and third switches are mutually coupled to provide an output of the mixer, while the second and fourth switched are mutually coupled to provide another output of the mixer. Each of the first, second, third and fourth switches determines whether to allow the differential current signal to pass through according to a differential control signal.

### CROSS REFERENCE TO RELATED PATENT APPLICATION

This patent application is based on Taiwan, R.O.C. patent application No. 98116506 filed on May 19, 2009.

### FIELD OF THE INVENTION

The present invention relates to a mixer, and more particularly to a mixer with high linearity and a low operating voltage.

### BACKGROUND OF THE INVENTION

In a wireless transmitter or a radio frequency (RF) transmitter, a mixer is a widely-used frequency conversion unit. FIG. 1 shows a conventional wireless transmitter 10, which converts a baseband transmission signal to an RF transmission signal to be transmitted through an antenna. The wireless transmitter 10 comprises two filters 11 and 12, two programmable gain amplifiers 13 and 14, two mixers 15 and 16, and a power amplifier 17. The baseband transmission signal, taking a baseband I transmission signal for example, has its redundant frequency components eliminated via the filter 11. The baseband transmission signal is then amplified by the programmable gain amplifier 13, transmitted to the mixer 15 and converted into an RF I signal via an oscillating signal LO_{I} generated by a local oscillator (not shown). A baseband Q transmission signal is converted into an RF Q signal by a similar manner and transmitted with the RF I signal to the power amplifier 17 to be amplified for proceeding with wireless transmission. In the wireless transmitter 10, frequency conversion, performed by the mixers 15 and 16, has a crucial effect on signal quality of the wireless transmission.

FIG. 2 illustrates a circuit diagram of a conventional mixer, wherein a Gilbert mixer 20 comprises a transconductor 21, a switch quad 22 and a load circuit 23. The load circuit 23 comprises loads 231 and 232, wherein each of the loads 231 and 232 has two ends, with the first end coupled to a voltage source Vcc, and the second end coupled to an output end Out. The switch quad 22 comprises four n-type transistors M3, M4, M5 and M6. Each drain of M3 and M5 is coupled to the second end of the load 231; each drain of M4 and M6 is coupled to the second end of the load 232. Further, gates of M3 and M6 are mutually coupled, and gates of M4 and M5 are mutually coupled; the gates of M3 and M4 receive a local oscillating signal LO. Moreover, sources of M3 and M4 are mutually coupled to form a first current path; sources of M5 and M6 are mutually coupled to form a second current path.

The transconductor 21 comprises two n-type transistors Ml and M2. The drain of M1 is coupled to the first current path of the switch quad 22; The drain of M2 is coupled to the second current path of the switch quad 22. The gate of M1 receives a voltage signal Vin⁺; The gate of M2 receives a voltage signal Vin⁻. Further, the sources of M1 and M2 are mutually coupled. An n-type transistor Ms is coupled between the source of M1 and ground. The gate of the transistor Ms is inputted in a stable voltage such that the n-type transistor Ms provides a current source.

FIG. 3 illustrates an associated signal schematic diagram of the conventional mixer 20. The transconductor 21 converts an input voltage signal Vin, i.e., Vin⁺−Vin⁻, into a current signal Ib. When passing through the first current path and the second current path of the switch quad 22, the current signal Ib becomes a frequency-converted current signal driven by the oscillating signal LO. Then, the frequency-converted current signal is converted by the load circuit 23 to output the output voltage Vcc.

For the wireless transmitter, a signal swing of an input/output signal needs to be large to enhance a signal-to-noise ratio (SNR) so as to allow the input/output signal to be immune from a noise and to reduce a local oscillation leakage (LO leakage) effect. However, since electronic apparatuses have a trend of a decreasing size, an integrated circuit (IC) needs to be smaller and smaller while an operating voltage has to become lower and lower. Therefore, under such low operating voltage condition, it is an issue to be discussed as how the transmission signal swing can remain large when the mixer is designed in the wireless transmitter.

On the other hand, as shown in FIG. 2, in the conventional mixer 20, since the transconductor 21 comprises the transistors M1 and M2, its current is a square function of its voltage but not a linear function. In other words, the conventional mixer is not applicable to the mixer with high linearity, such as a wireless local area network (WLAN) transmitter and a code division multiple access (CDMA) transmitter.

### SUMMARY OF THE INVENTION

As a result, one object of the present invention is to provide a mixer with high linearity to avoid a non-linear problem in a transconductor of a conventional mixer.

Another object of the present invention is to provide a mixer with a low operating voltage for lowering the operating voltage and still maintaining a large input/output signal swing.

The present invention discloses a mixer comprising a transconductor and a switch circuit. The transconductor receives a pair of differential voltage signals and outputs a pair of differential current signals. The transconductor comprises a first resistor and a second resistor, and a differential amplifier. The differential amplifier comprises a first input end, a second input end, a first output end, and a second output end, wherein the pair of differential voltage signals are transmitted to the first input end and the second input end via the first resistor and the second resistor respectively, and the pair of differential current signals are outputted from the first input end and the second input end respectively. The transconductor further comprises a first current source and a second current source, coupled to the first input end and the second input end respectively. The switch circuit comprises a first switch, a second switch, a third switch, and a fourth switch, where the first switch and the second switch are coupled to the first input end, the third switch and the fourth switch are coupled to the second input end, the first switch and the third switch are mutually coupled to provide an output for the mixer, and the second switch and the fourth switch are mutually coupled to provide another output for the mixer. The first switch, the second switch, the third switch, and the fourth switch control whether to allow the pair of differential current signals to pass therethrough according to a pair of differential control signals; wherein, the first output end is coupled to the first switch and the second switch, such that the first output end and the first input end of the differential amplifier form a negative feedback loop, and the second output end is coupled to the third switch and the fourth switch, such that the second output end and the second input end of the differential amplifier form another negative feedback loop.

### BRIEF DESCRIPTION OF THE DRAWINGS

The present invention will become more readily apparent to those ordinarily skilled in the art after reviewing the following detailed description and accompanying drawings, in which:

FIG. 1 illustrates a schematic diagram of a conventional wireless transmitter;

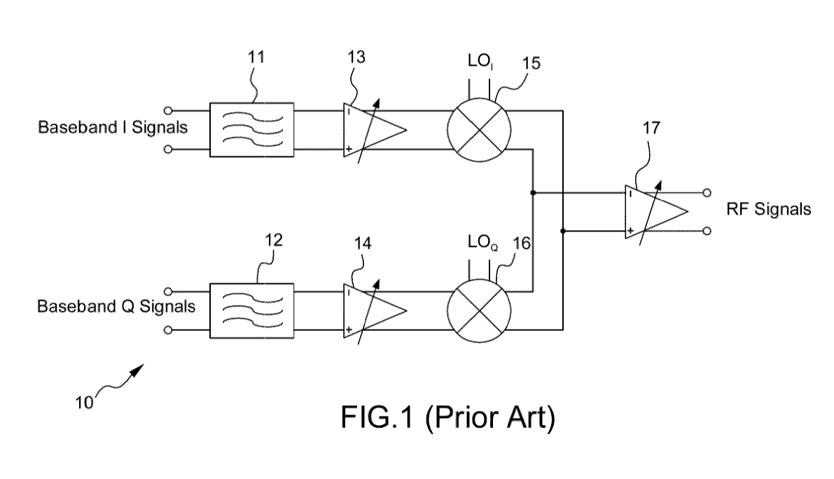

FIG. 2 illustrates a circuit diagram of a conventional mixer;

FIG. 3 illustrates an associated signal schematic diagram of the conventional mixer;

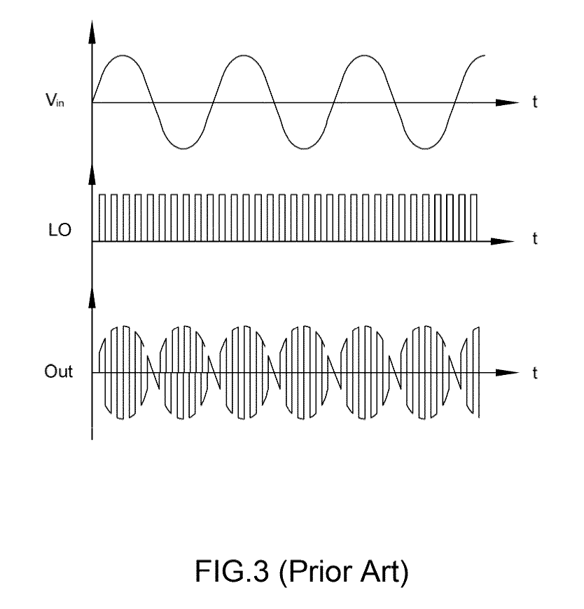

FIG. 4 shows a circuit diagram of a mixer according to one embodiment of the present invention; and

FIG. 5 shows a circuit diagram of an isolation circuit according to one embodiment of the mixer in FIG. 4.

### DETAILED DESCRIPTION OF THE PREFERRED EMBODIMENT

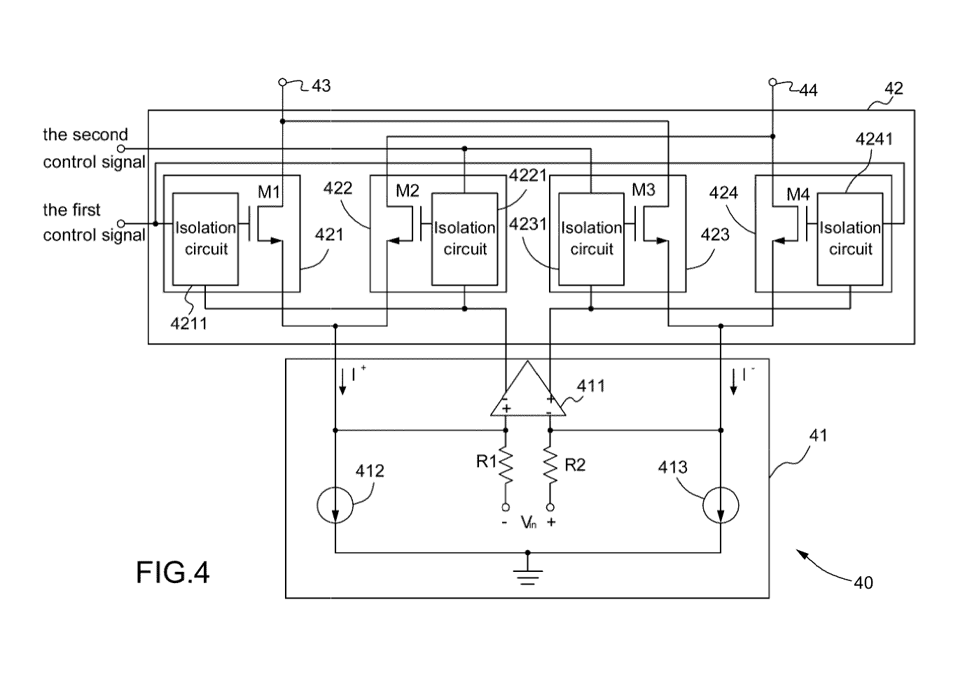

FIG. 4 illustrates a circuit diagram of a mixer 40 according to one embodiment of the present invention. The mixer 40 comprises a transconductor 41 and a switch quad 42. The transconductor 41 receives a pair of differential input voltages Vin⁺ and Vin⁻ and outputs a pair of differential current signals I⁺ and I⁻. The transconductor 41 comprises two resistors R1 and R2, a differential amplifier 411 and two current sources 412 and 413. The differential input voltages Vin⁻ and Vin⁺ are inputted into a positive input end and a negative input end of the differential amplifier 411 via the resistors R1 and R2 respectively. The current source 412 is coupled between the positive input end and ground; the current source 413 is coupled between the negative input end and ground. The differential current signals I⁺ and I⁻ are outputted from the positive input end and the negative input end respectively.

The switch quad 42 comprises four switches 421, 422, 423 and 424. The switch 421 comprises a transistor M1 and an isolation circuit 4211, the switch 422 comprises a transistor M2 and an isolation circuit 4221, the switch 423 comprises a transistor M3 and an isolation circuit 4231, and the switch 424 comprises a transistor M4 and an isolation circuit 4241. Sources of the transistors M1 and M2 are both coupled to the positive input end of the differential amplifier 411; sources of the transistors M3 and M4 are both coupled to the negative input end of the differential amplifier 411. Drains of the transistors M1 and M3 are mutually coupled to provide an output end 43 of the mixer 40; drains of the transistors M2 and M4 are mutually coupled to provide another output end 44 of the mixer 40.

The switches 421, 422, 423 and 424 control whether to allow the differential current signals I⁺ and I⁻ to pass through according to a pair of differential control signals. The pair of differential control signals, comprising a first control signal and a second control signal, are transmitted to each gate of the transistors M1 and M2 via the isolation circuits 4211 and 4221 respectively, to control the switches 421 and 422 whether to allow the current signal I⁺ to pass through. The first control signal and the second control signal are also transmitted to each gate of the transistors M4 and M3 via the isolation circuits 4241 and 4231 respectively, to control the switches 424 and 423 whether to allow the current signal I⁻ to pass through (functions of the isolation circuits 4211, 4221, 4231 and 4241 are described later). The pair of differential control signals can be generated by a local oscillator. By controlling a frequency of the pair of differential control signals adequately to switch the switches 421, 422, 423 and 424, the frequency of the pair of differential current signals I⁺ and I⁻ can be converted into a desired frequency and then be outputted to the output ends 43 and 44.

As shown in FIG. 4, a negative output end of the differential amplifier 411 is coupled to each gate of the transistors M1 and M2 via the isolation circuits 4211 and 4221 respectively to form a negative feedback loop between the negative output end and the positive input end of the differential amplifier 411. On the other hand, a positive output end of the differential amplifier 411 is coupled to each gate of the transistors M3 and M4 via the isolation circuits 4231 and 4241 respectively to form another negative feedback loop between the positive output end and the negative input end of the differential amplifier 411. Linearity of the transconductor 41 can be increased by these negative feedback loops. Reasons are as follows. A voltage of the negative output end and the positive output end of the differential amplifier 411 varies with the differential input voltages Vin⁺ and Vin⁻, and the differential current signals I⁺ and I⁻ are varied in response to the voltage of the negative output end and the positive output end through the negative feedback loops; hence, the differential current signals I⁺ and I⁻ also vary with the differential input voltages Vin⁺ and Vin⁻. Further, a relation between an output current Iₒᵤₜ, i.e., I⁺−I⁻, and an input voltage Vᵢₙ, i.e., Vin⁺−Vin⁻, of the transconductor 41 can be derived below:

$${I}_{out} = {I}^{+} - {I}^{-} = \frac{\frac{{V}_{in}}{2}}{{R}_{1}} - \frac{\frac{- {V}_{in}}{2}}{{R}_{2}} \qquad Eq . ( 1 )$$

When the transconductor 41 is a fully differential circuit and R1=R2, Eq.(1) can be simplified to

$${I}_{out} = \frac{{V}_{in}}{{R}_{1}}$$

Therefore, the relation between the output current Iₒᵤₜ and the input voltage Vᵢₙ of the transconductor 41 become linear; that is, the transconductor 41 has a linear transconductance. Consequently, the mixer 40 has high linearity by using the transconductor 41.

In FIG. 4, since signals, outputted from the first control signal and the negative output end of the differential amplifier 411, are both coupled to the gate of the transistor M1, the switch 421 adds the isolation circuit 4211 to isolate the signals outputted from the first control signal and the negative output end respectively, so as to avoid an interference between these two signals. For the same reason, the isolation circuit 4221 isolates signals outputted from the second control signal and the negative output end respectively, the isolation circuit 4231 isolates signals outputted from the second control signal and the positive output end respectively. The isolation circuit 4241 isolates signals outputted from the first control signal and the positive output end respectively.

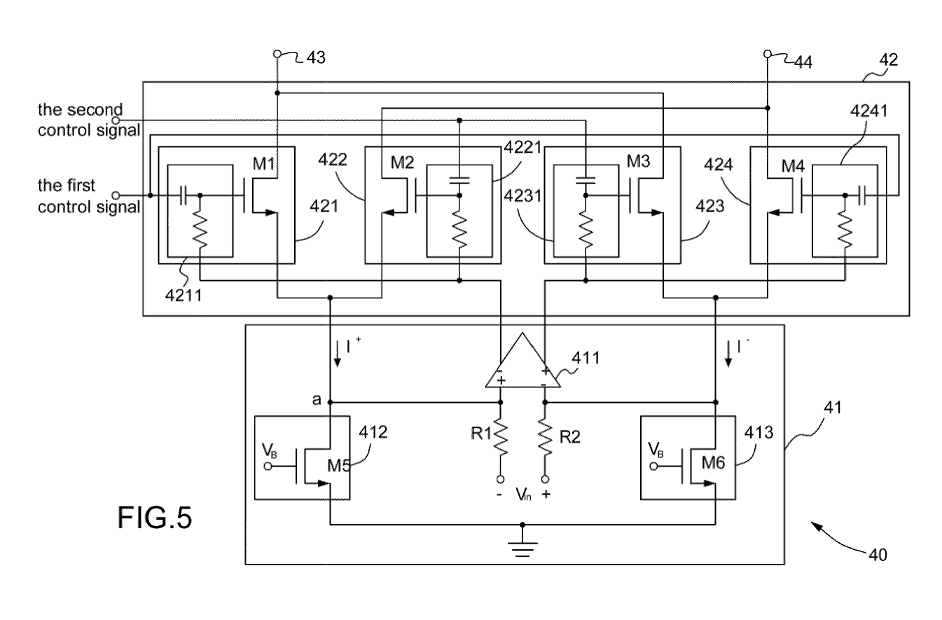

While the first control signal and the second control signal are high frequency signals, the signals, outputted from the positive output end and the negative output end, are low frequency signals; the isolation circuits 4211, 4221, 4231 and 4241 can be realized as shown in FIG. 5. Each isolation circuit comprises a high pass filter (e.g., a capacitor in FIG. 5) and a low pass filter (e.g., a resistor in FIG. 5). The high pass filter is coupled between a high frequency signal, i.e., the first or the second control signal, and the gate of the transistor; the low pass filter is coupled between a low frequency signal, i.e., the signals outputted from the positive output end or the negative output end, and the gate of the transistor. For the high frequency signal, it is able to pass through the high pass filter to reach the gate but unable to pass through the low pass filter to interfere the low frequency signal; for the low frequency signal, it is able to pass through the low pass filter to reach the gate but unable to pass through the high pass filter to interfere the high frequency signal. Hence, the high frequency signal and the low frequency signal are isolated from each other.

The mixer 40 additionally can operate with a low operating voltage. The following takes computing a required gate operating voltage of the transistor M1 for example, whereas each required gate operating voltage of the transistors M2, M3, and M4 is similar. The meaning of the required gate operating voltage is that, throughout the mixer 40 operation, the gate has to maintain above such voltage value, or the mixer 40 cannot function well. With reference to FIG. 5, current sources 412 and 413 are realized by transistors M5 and M6 respectively. A gate voltage of the transistor M1 is

V_{G1}=Vₐ+V_{GS1} Eq.(2)

Wherein, Vₐ is the voltage of point a, and V_{GS1} is a gate-to-source voltage of the transistor M1. Since point a is the positive input end of the differential amplifier 411, Vₐ is a common mode input voltage of the differential amplifier 411, denoted as V_{icm} in the following. V_{GS1} includes a direct current and an alternating current. The direct current is generated from biasing the transistor M1. Note that the transistor M1 needs to operate in a saturation region so that the mixer 40 can function well. Therefore, such direct current needs to be at least V_{Dsat1}+V_{TH1}, wherein V_{Dsat1} and V_{TH1} represent a drain saturation voltage and a threshold voltage of the transistor M1 respectively. The alternating current is generated from a voltage variation (denoted as ΔV_{GS1}) of the input voltage Vᵢₙ, whose computation is as follows:

Provided that a transconductance of the transistor M1 is gₘ₁, then:

ΔV_{GS1}=ΔI_{D1}/gₘ₁ Eq.(3)

Wherein, ΔI_{D1} is the drain current of the transistor M1. Since I⁺ is equal to the sum of both drain currents of the transistors M1 and M2, ΔI_{D1}=I⁺/2. Consequently, Eq.(3) can be represented as:

$$Δ {V}_{GS 1} = \frac{\frac{{I}^{+}}{2}}{{g}_{m 1}} = \frac{{V}_{in}}{4 {g}_{m 1} {R}_{1}} \qquad Eq . ( 4 )$$

Provided that a maximal amplitude of the input voltage Vᵢₙ, i.e., a maximal difference between the differential voltage signals Vin⁺ and Vin⁻, is Vs, according to Eq.(2) and Eq.(4), a required gate operating voltage of the transistor M1, V_{G1min}, is derived as:

$$\begin{matrix}{V}_{G 1 min} = {V}_{icm} + {V}_{Dsat 1} + {V}_{TH 1} + \frac{{V}_{s}}{4 {g}_{m 1} {R}_{1}} \\ = {V}_{Dsat 5} + {V}_{Dsat 1} + {V}_{TH 1} + \frac{{V}_{s}}{4 {g}_{m 1} {R}_{1}}\end{matrix} \qquad Eq . ( 5 )$$

Wherein, V_{icm} is a drain saturation voltage of the transistor M5, V_{Dsat5}.

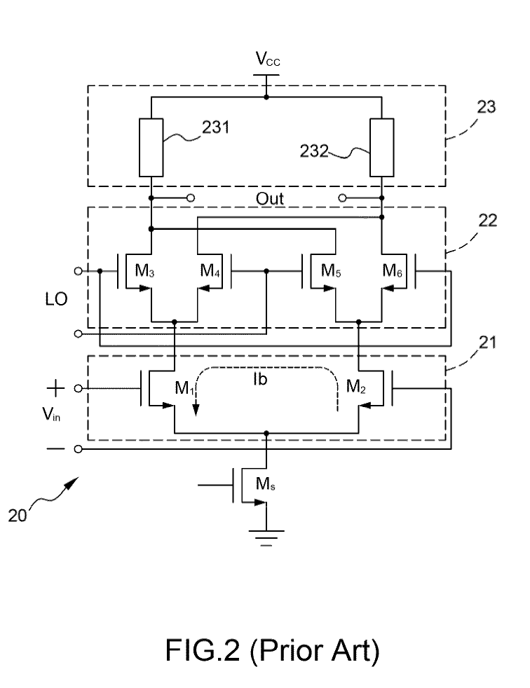

With reference to a conventional mixer 20 as shown in FIG. 2, a required gate operating voltage of a transistor M3 is

$$\begin{matrix}{V}_{G 3 min} = {V}_{Dsats} + {V}_{Dsat 1} + {V}_{GS 3} + \frac{{V}_{s}}{2} \\ = {V}_{Dsats} + {V}_{Dsat 1} + {V}_{Dsat 3} + {V}_{TH 3} + \frac{{V}_{s}}{2}\end{matrix} \qquad Eq . ( 6 )$$

Wherein, V_{Dsats}, V_{Dsat1} and V_{Dsat3} represent each drain saturation voltage of transistors Ms, M1 and M3 respectively in the conventional mixer 20, V_{TH3} represents a threshold voltage of the transistor M3 in the conventional mixer 20, and Vs represents a maximal difference between differential voltage signals Vin⁺ and Vin⁻.

Suppose the conventional mixer 20, according to FIG. 2, and the mixer 40, according to the present invention, both use transistors of the same specification. It is observed from Eq.(5) with Eq.(6), by selecting the resistor R1 with a high resistance value in the mixer 40, the required gate operating voltage of the transistor M1 in the mixer 40 is lower than that of the transistor M3 in the conventional mixer 20. Since the operating voltage of the mixer 40 according to the present invention can be lowered, the input voltage Vᵢₙ with greater amplitude can be used to improve a signal-to-noise ratio to provide a mixer with better performance.

With reference to FIG. 4, the differential amplifier 411 determines its common mode output voltage by an internal common mode feedback circuit (not shown), for providing direct current biases of the transistors M1, M2, M3 and M4. According to the above Eq.(5), a direct current bias of the transistor M1, i.e., the direct current portion of V_{G1}, needs at least V_{icm}+V_{Dsat1}+V_{TH1}; that is, a minimal value of the common mode output voltage of the differential amplifier 411 can be determined according to the common mode input voltage of the differential amplifier 411 and the drain saturation voltage and the threshold voltage of the transistor M1.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

1. A mixer, comprising:
a first mixer output end;
a second mixer output end;
a transconductor, for receiving a differential voltage signal and outputting a differential current signal, comprising:
a first resistor and a second resistor;
a differential amplifier, comprising a first differential amplifier input end, a second differential amplifier input end, a first differential amplifier output end, and a second differential amplifier output end, wherein the differential voltage signal is transmitted to the first differential amplifier input end and the second differential amplifier input end via the first resistor and the second resistor, and the differential current signal is outputted from the first differential amplifier input end and the second differential amplifier input end; and
a first current source and a second current source, coupled to the first differential amplifier input end and the second differential amplifier input end respectively; and
a switch quad, comprising a first switch, a second switch, a third switch and, a fourth switch, wherein the first switch and the second switch are coupled to the first differential amplifier input end, the third switch and the fourth switch are coupled to the second differential amplifier input end, the first switch and the third switch are coupled to the first mixer output end, the second switch and the fourth switch are coupled to the second mixer output end, and the first switch, the second switch, the third switch, and the fourth switch are controlled by a differential control signal;
wherein, the first differential amplifier output end is coupled to the first switch and the second switch, such that the first differential amplifier output end and the first differential amplifier input end form a first negative feedback loop, and the second differential amplifier output end is coupled to the third switch and the fourth switch, such that the second differential amplifier output end and the second differential amplifier input end form a second negative feedback loop.

2. The mixer according to claim 1, wherein the differential control signal is generated by a local oscillator.

3. The mixer according to claim 1, wherein the differential control signal comprises a first control signal for controlling the first switch and the fourth switch, and a second control signal for controlling the second switch and the third switch.

4. The mixer according to claim 3, wherein the first switch, the second switch, the third switch, and the fourth switch comprise a first transistor, a second transistor, a third transistor, and a fourth transistor respectively.

5. The mixer according to claim 4, wherein the first switch comprises a first isolation circuit and the second switch comprises a second isolation circuit, wherein the first control signal is transmitted to a gate of the first transistor via the first isolation circuit, the second control signal is transmitted to a gate of the second transistor via the second isolation circuit, the first differential amplifier output end is coupled to the gates of the first transistor and the second transistor via the first isolation circuit and the second isolation circuit respectively, and a signal outputted from the first differential amplifier output end is isolated from the first control signal and the second control signal by the first isolation circuit and the second isolation circuit respectively.

6. The mixer according to claim 5, wherein the first isolation circuit comprises a first high pass filter coupled between the first control signal and the gate of the first transistor, and a first low pass filter coupled between the first differential amplifier output end and the gate of the first transistor, and the second isolation circuit comprises a second high pass filter coupled between the second control signal and the gate of the second transistor, and a second low pass filter coupled between the first differential amplifier output end and the gate of the second transistor.

7. The mixer according to claim 6, wherein the first low pass filter comprises a first resistor and the second low pass filter comprises a second resistor respectively.

8. The mixer according to claim 6, wherein the first high pass filter comprises a first capacitor and the second high pass filter comprises a second capacitor respectively.

9. The mixer according to claim 4, wherein the third switch comprises a third isolation circuit, the fourth switch comprises a fourth isolation circuit, wherein the first control signal is transmitted to a gate of the fourth transistor via the fourth isolation circuit, the second control signal is transmitted to a gate of the third transistor via the third isolation circuit, the second differential amplifier output end is coupled to the gates of the third transistor and the fourth transistor via the third isolation circuit and the fourth isolation circuit respectively, and a signal outputted from the second differential amplifier output end is isolated from the first control signal and the second control signal by the fourth isolation circuit and the third isolation circuit respectively.

10. The mixer according to claim 9, wherein the third isolation circuit comprises a third high pass filter coupled between the second control signal and the gate of the third transistor, and a third low pass filter coupled between the second differential amplifier output end and the gate of the third transistor, and the fourth isolation circuit comprises a fourth high pass filter coupled between the first control signal and the gate of the fourth transistor, and a fourth low pass filter coupled between the second differential amplifier output end and the gate of the fourth transistor.

11. The mixer according to claim 10, wherein the third low pass filter comprises a third resistor and the fourth low pass filter comprises a fourth resistor respectively.

12. The mixer according to claim 10, wherein the third high pass filter comprises a third capacitor and the fourth high pass filter comprises a fourth capacitor respectively.

13. The mixer according to claim 4, wherein the differential voltage signal further comprises a first differential voltage signal and a second differential voltage signal, and the differential amplifier determines a common mode output voltage according to a common mode input voltage of the differential amplifier, a swing of the first differential voltage signal and of the second differential voltage signal, and a operating voltage of one of the first transistor, the second transistor, the third transistor, and the fourth transistor.

14. The mixer according to claim 13, wherein the common mode input voltage is determined according to a voltage drop of one of the first current source and the second current source.

15. The mixer according to claim 14, wherein each of the first current source and the second current source is a transistor current source.

16. A mixer, comprising:
a mixer output end;
a transconductor, for receiving a differential voltage signal and outputting a differential current signal, comprising:
a resistor;
a differential amplifier, comprising a differential amplifier input end and a differential amplifier output end, wherein the differential voltage signal is transmitted to the differential amplifier input end via the resistor, and the differential current signal is outputted from the differential amplifier input end; and
a current source coupled to the differential amplifier input end; and
a switch quad, comprising a switch, wherein the switch is coupled to the differential amplifier input end and the mixer output end, and the switch is controlled by a differential control signal;
wherein, the differential amplifier output end is coupled to the switch, such that the differential amplifier output end and the differential amplifier input end form a negative feedback loop.
